(19) United States
(12) Patent Application Publication
(10) Pub. No.: US 2023/0153724 A1
(43) Pub. Date: May 18, 2023

(54) Automated Marketing System

(71) Applicant: Play Games24x7 Private Limited, Miami Beach, FL (US)

(72) Inventors: Trivikraman Thampy, Miami Beach, FL (US); Brian O'Neill, Phoenixville, PA (US); Paul Smith, Ridgewood, NJ (US); Anthony Putignano, Cherry Hill, NJ (US); Manu Gambhir, Philadelphia, PA (US)

(21) Appl. No.: 17/983,580

(22) Filed: Nov. 9, 2022

Related U.S. Application Data
(60) Provisional application No. 63/280,229, filed on Nov. 17, 2021.

(51) Int. Cl. G06Q 10/06

(52) U.S. Cl. CPC G06Q 10/0633; G06Q 10/06393

(57) ABSTRACT

An automated marketing system includes an interactive display that is configured to display blocks to generate a computer-executable workflow structure for a marketing operation. The blocks contain rules, logic, or both, and are used to construct the computer-executable workflow structure of the marketing operation. The data associated with the blocks is parsed and compiled into a marketing operation. The system executes the computer-executable workflow structure by transmitting one or more messages to one or more members of an audience. The system is configured to obtain and store metrics associated with the executed computer-executable workflow structure.

### CROSS-REFERENCE TO RELATED APPLICATION(S)

This application claims priority to and the benefit of U.S. Provisional Patent Application Ser. No. 63/280,229, filed Nov. 17, 2021, the entire disclosure of which is hereby incorporated by reference.

### SUMMARY

Disclosed herein are implementations of an automated marketing system and method. In an aspect, an automated marketing method may include obtaining a first input via a user interface (UI). The automated marketing method may include generating a computer-executable workflow structure. The computer-executable workflow structure may be associated with a marketing operation. The computer-executable workflow structure may be generated based on the first input. The automated marketing method may include parsing the computer-executable workflow structure to obtain a parse structure. The automated marketing method may include executing validation rules against the parsed structure to determine whether the computer-executable workflow structure is valid. The automated marketing method may include obtaining a second input. The automated marketing method may include executing the computer-executable workflow structure in response to the second input when the computer-executable workflow structure is valid.

In an aspect, an automated marketing system may include a server. The server may include a processor that is configured to obtain a first input via a UI. The processor may be configured to generate a computer-executable workflow structure associated with a marketing operation. The processor may generate the computer-executable workflow structure based on the first input. The processor may be configured to parse the computer-executable workflow structure to obtain a parsed structure. The processor may be configured to execute validation rules against the parsed structure to determine whether the computer-executable workflow structure is valid. The processor may be configured to obtain a second input. The processor may be configured to execute the computer-executable workflow structure in response to the second input when the computer-executable workflow structure is valid.

In an aspect, a non-transitory computer-readable medium may include instructions stored in a memory, that when executed by a processor, cause the processor to perform operations including obtaining a first input via a UI. The operations may include generating a computer-executable workflow structure. The computer-executable workflow structure may be associated with a marketing operation. The computer-executable workflow structure may be generated based on the first input. The operations may include parsing the computer-executable workflow structure to obtain a parsed structure. The operations may include executing validation rules against the parsed structure to determine whether the computer-executable workflow structure is valid. The operations may include obtaining a second input. The operations may include executing the computer-executable workflow structure in response to the second input when the computer-executable workflow structure is valid.

In one or more aspects, a notification may be displayed on the UI when the computer-executable workflow structure is invalid. In one or more aspects, the computer-executable workflow structure may be generated in JavaScript Object Notation (JSON). In one or more aspects, executing the computer-executable workflow structure may include determining an audience based on the parsed structure. In one or more aspects, executing the computer-executable workflow structure may include generating a message based on the parsed structure. In one or more aspects, executing the computer-executable workflow structure includes transmitting the message to the audience. In one or more aspects, event information may be obtained from an end-user device. In one or more aspects, the message may be transmitted to the end-user device based on the event information. In one or more aspects, the parsed structure may be converted into Common Expression Language. In one or more aspects, the converted parsed structure may be compiled. In one or more aspects, metrics may be obtained based on the executed computer-executable workflow structure.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a diagram of an example of an automated marketing system.

FIG. 2 is a diagram of an example of the automated marketing system shown in FIG. 1.

FIG. 3 is an example of a GUI display of an automated marketing system that shows a panel that contains blocks that can be dragged and dropped to an adjacent work area to create an execution flow.

FIG. 4 is an example of a GUI display of the automated marketing system for creating an audience.

FIG. 5 is an example flow diagram for an opportunistic coercion operation.

FIG. 6 is a flow diagram of an example of an automated marketing method.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

As used herein, the terminology “computer” or “computing device” includes any unit, or combination of units, capable of performing any method, or any portion or portions thereof, disclosed herein.

As used herein, the terminology “processor” indicates one or more processors, such as one or more special purpose processors, one or more digital signal processors, one or more microprocessors, one or more controllers, one or more microcontrollers, one or more application processors, one or more central processing units (CPU)s, one or more graphics processing units (GPU)s, one or more digital signal processors (DSP)s, one or more application specific integrated circuits (ASIC)s, one or more application specific standard products, one or more field programmable gate arrays, any other type or combination of integrated circuits, one or more state machines, or any combination thereof.

As used herein, the terminology “memory” indicates any computer-usable or non-transitory computer-readable medium or device that can tangibly contain, store, communicate, or transport any signal or information that may be used by or in connection with any processor. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

As used herein, the terminology “instructions” may include directions or expressions for performing any method, or any portion or portions thereof, disclosed herein, and may be realized in hardware, software, or any combination thereof. For example, instructions may be implemented as information, such as a computer program, stored in memory that may be executed by a processor to perform any of the respective methods, algorithms, aspects, or combinations thereof, as described herein. Instructions, or a portion thereof, may be implemented as a special purpose processor, or circuitry, that may include specialized hardware for carrying out any of the methods, algorithms, aspects, or combinations thereof, as described herein. In some implementations, portions of the instructions may be distributed across multiple processors on a single device, on multiple devices, which may communicate directly or across a network such as a local area network, a wide area network, the Internet, or a combination thereof.

As used herein, the terminology “determine” and “identify,” or any variations thereof, includes selecting, ascertaining, computing, looking up, receiving, determining, establishing, obtaining, or otherwise identifying or determining in any manner whatsoever using one or more of the devices and methods shown and described herein.

As used herein, the terminology “example,” “embodiment,” “implementation,” “aspect,” “feature,” or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “or” is intended to mean an inclusive “or” rather than an exclusive “or.” That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from the context to be directed to a singular form.

As used herein, the terminology “consumption” includes utilization, operation, use, application, exploitation and any of the natural inclusive permutations.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

Marketing personnel are faced with the increasingly complex challenge of designing marketing operations that produce timely and relevant personalized messaging to their targets via any number of communication channels. Marketing operations include marketing campaigns, marketing promotions, marketing drives, and the like. The implementations described herein provide an automated marketing system that includes a visual no-code/lowcode language to enable marketing personnel to easily design and execute their marketing operations and gather metrics associated with the executed marketing operations. The gathered metrics may be used to determine future marketing operations.

A marketing operation may include one or more rules and/or logic that culminates in transmitting one or more messages to a group of current or prospective customers of a company that meet a certain criteria, i.e., an audience. The messages may be configured to cause the intended recipient to take some action such as clicking on a button. Messages can be in any form of communication, such as, for example, text messaging, emails, push notifications, WhatsApp notification, Facebook messenger, LinkedIn notification, Instagram, automated written letter, phone call, and any other suitable messaging application or service. Messages can be personalized for each recipient in their content, presentation, or both, for example, based on user data such as a user profile stored in a database.

The audience, may include a subset of user data in a database of current or prospective customers that can meet any arbitrary set of criteria. Examples include, “all women who spent at least $100 in the past 90 days,” “anyone who has logged in at least 3 times to my app but not yet made a purchase,” or “anyone whose past activity indicates they are at high risk for churning.”

The rules and logic can be complex and typically specify when a marketing operation should be triggered, what messaging should be delivered to each member of an audience, or both. For example, a set of rules and logic could be: “When it is Dec. 25, 2021, send the email ‘Xmas promotion’ to everyone who has not visited the website in 6 months.” A slightly more complex example could be: “When it is Dec. 25, 2021, for everyone who has not visited in the website in 6 months, send a randomly chosen half of them the email ‘Xmas promotion 1’ and the other half ‘Xmas promotion 2.’” Adding one more step to the complexity, the rules and logic could be expanded to say, for example, “When it is Dec. 25, 2021, for everyone who has not visited in the website in 6 months, send a randomly chosen half of them the email ‘Xmas promotion 1’ and the other half ‘Xmas promotion 2’ via push notification, and for recipients of ‘Xmas promotion 1’ who have not opened the email within 72 hours then send them the ‘Xmas promotion 2’ via push notification.” Based on the particular campaign, the complexity of the rules and logic can be infinitely expanded.

Providing marketing personnel an interface whereby they can easily express arbitrarily complex rules and logic is critical to allowing them to design marketing operations that are engaging and increase the chances of the recipients of the messages taking the action desired by the marketing personnel. The embodiments disclosed herein include an automated marketing system and a graphical user interface (GUI) for designing and executing marketing operations.

Modern marketing personnel are increasingly technically savvy and are operating in a highly competitive world. They are aware that their marketing operations need to be highly targeted, timely, relevant and personalized and use the recipients preferred channels of communications in order to maximize their chances of success. The rules and logic are a very critical part of designing the marketing operation. The vast majority of existing marketing operation design platforms in the market allow marketing personnel to construct a marketing operation by constructing a visual flowchart to express the rules and logic of the marketing operation. The visual flowchart interface, while easy to learn and use, quickly becomes cumbersome and limited when the rules and logic for a marketing operation are anything more than relatively simplistic. This can be more easily understood by thinking about the fact that computer programming languages, such as Python, Java, Swift or any number of others, enable computer programmers to implement virtually any rules and logic they can think of to make their computer programs produce the desired results. A traditional text-based programming language, however, would not be appealing to marketing personnel as it would require them to have a computer programming background. The embodiments disclosed herein address problems such as these by providing an automated marketing system. The automated marketing system may execute a visual programming language that is as powerful as any text-based computer programming language but far easier to learn and use.

The automated marketing system is configured to run a visual drag-and-drop programming language that is designed for marketing personnel. The automated marketing system enables marketing personnel to construct their rules and logic by dragging and dropping individual blocks displayed on a GUI to connect them together to form a computer-executable workflow structure (e.g., an execution flow) for a marketing operation.

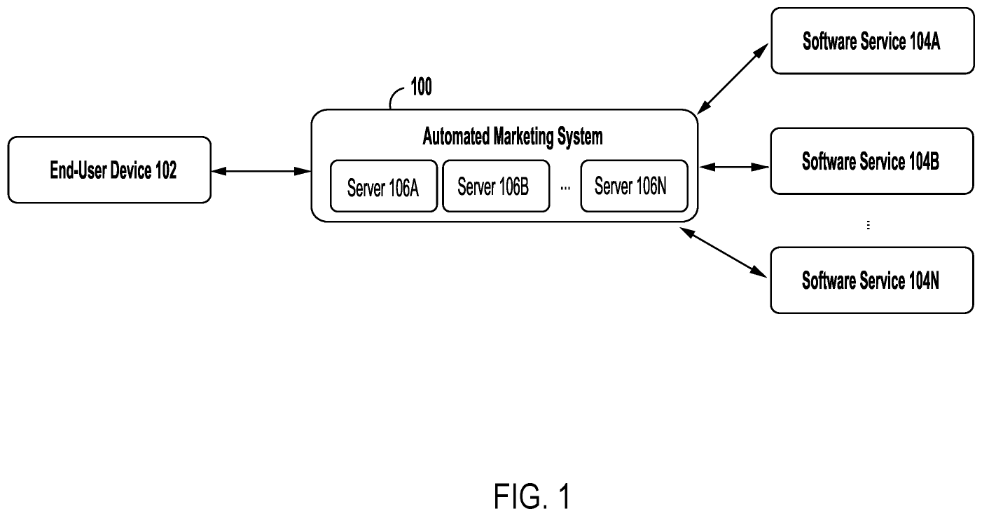

FIG. 1 is a diagram of an example of an automated marketing system 100. As shown in FIG. 1, the automated marketing system 100 is configured to communicate with an end-user device 102 and one or more software services 104A-104N. The end-user device 102 may be a computing device such as a personal computer, a laptop computer, a tablet device, a mobile device (e.g., a mobile phone), or any other computing device. The end-user device 102 is configured to communicate with the automated marketing system 100 via a wired or wireless communication channel.

The automated marketing system 100 includes one or more servers 106A-106N. The one or more servers 106A-106N may be hardware or software servers. The one or more servers 106A-106N are configured to communicate with the one or more software services 104A-104N. the one or more software services 104A-104N are configured to enable communications over one or more modalities such as email, text messaging, push notifications, social media, automated written letter, telephony (e.g., a phone call) or any combination thereof.

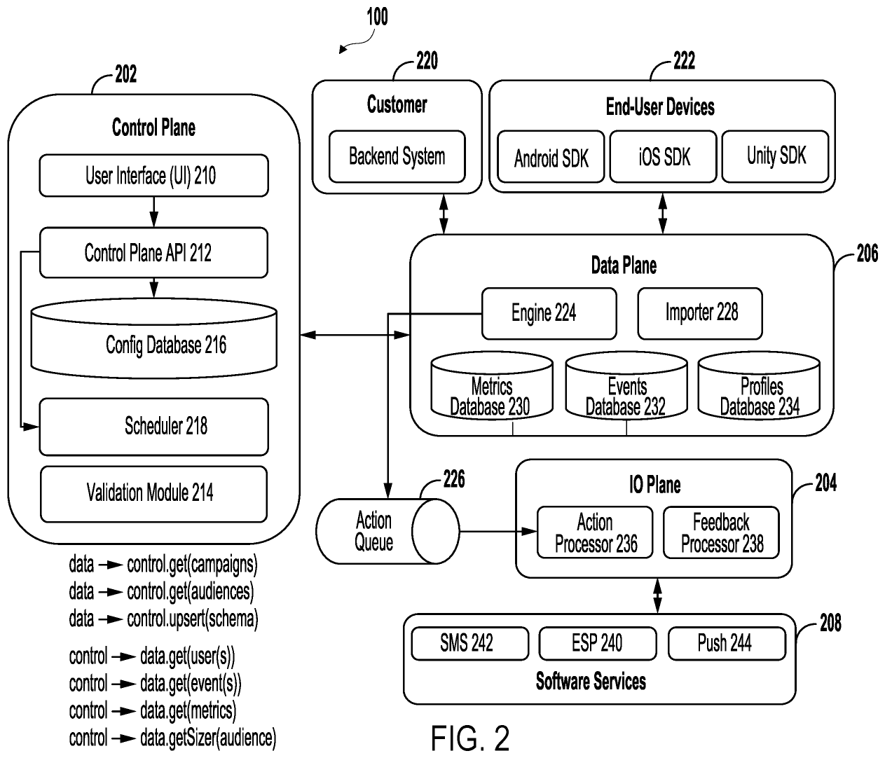

FIG. 2 is a diagram of an example of the automated marketing system 100 shown in FIG. 1. The automated marketing system 100 is configured for generating automated marketing operations. At a high-level, there are three planes in the architecture: a control plane 202, an input/output (IO) plane 204, and a data plane 206. The three planes may be implemented on one or more servers, such as the servers 106A-106N shown in FIG. 1. The one or more servers 106A-106N may be hardware servers or software servers. A user, such as a marketing personnel, may interact with the control plane 202 to administer their marketing operations, workflows, audiences and creatives. The data plane 206 is configured as a high-volume subsystem. The data plane 206 is configured to process events, evaluate those events against user profiles, event histories and marketing operations, render content, and determine what action to take. The IO plane 204 processes actions generated by the data plane 206, and receives feedback from the software services 208 used for customer communication. The software services 208 can be the software services 104A-104N shown in FIG. 1.

There are multiple components within the control plane 202. One component is the UI 210, which is what a user (e.g., marketing personnel) interacts with. In an example, the UI 210 may run in a web browser on an end-user device. The UI 210 is configured to communicate with the control plane API 212. The UI 210 implements the front-end code that is used to generate the blocks for display on the GUI. The control plane API 212 may include a set of services that update the programs of the system. The programs are configured to run the marketing operations.

The control plane 202 also contains the validation module 214. The validation module 214 parses the marketing operation/workflow structure and executes validation rules against that parsed structure. The validation module 214 may be written in typescript, which allows it to be used in both the front-end as well as server-side. The config database 216 is a persistent storage device for the marketing operations that the marketers have configured. Some of those marketing operations are configured to execute at a particular time. The scheduler 218 is a module that periodically examines the marketing operations and orchestrates the scheduled execution of the marketing operations.

Marketing operations may be generated in JavaScript Object Notation (JSON). An example JSON generated for an example marketing operation is shown below.

“blocks”: [{
“id”: “2ade86a7-e536-42c3-aed0-16beedf980fc”
“type”: ″whenEvent″,
“event”: “traitChange”,
“children”: [{
“id”: “a71 e4df4-074f-4191 -9aab-a68a08093dc5”,
“type”: “forUser”,
‘‘children’’: “[{‘‘id’’: “f8aa9c4d-a91b-4118-a209-6550aaeae0a2’’,
“type”: “publish”,
“children”: [],
“channelld”: “dl24ced0-30e2-481e-ad95-a92f5fc409b2”,
“templateld”: “6159 le3f-18e9-4542-9e82-9dac 19dd0f6b”,
“channelType”: “push”,
}]}],
“criteria”: {
“$and”: [{“event.properties.field.string”:
{“$eq”: “my_new_interest_level_trait”}}, {
“event.properties.oldValue.number”: {“$lt”: 2}}, {
″event.properties.newValue.number”: {$gte”: 2}}]}}],

As shown in the example JSON above, the marketing operation forms a tree structure. Blocks are typed (e.g. “publish”), and have attributes (e.g channelId) and children. The JSON is generated, validated, and stored by the control plane 202, then processed by the data plane 206.

Referring back to FIG. 2, the data plane 206 is where the majority of central processing unit (CPU) cycles are spent. Events are generated by end-user devices or a backend customer system 220. The end-user devices 222 may include an embedded software development kit (SDK) into an application, which transmits events on behalf of the application or through function calls. In some examples, integrations, such as channel integrations (e.g., software services), transmit their events to the data plane 206 for processing. The data plane 206 implements an API for data ingestion, such as, for example, Segment's HTTP API. In an example, a client may use a batch endpoint to transmit a set of events in a single HTTP request.

The automated marketing system 100 may be configured to support two or more types of events. Example events may include, and are not limited to, track events and identify events. Track events may communicate user behavior. Each Track event (e.g. game_played) may have a time associated with it and a set of properties.

Example Track Event:

```
{
  ″type″: ″track″,
  ″messageId″: ″483691a6-55d5-40f2-a046-aa0b3946d49b″
  ″anonymousId″: ″23119130.00000″,
  ″userId″: ″Brian″,
  ″event″: ″gameplayed″,
  ″timestamp″: ″2020-09-22119:00:02.733148-04:00″,
  ″context″: {
    ″library″: {
      ″name″: ″analytics-go″,
      ″version″: ″1.0.0″
    }
  },
  ″properties″: {
      ″channelId″: 3,
      ″email″: “bone@ alumni.brown.edu”,
      ″entryFee″: 10,
      ″formatType″: 100,
      ″gameEndOn″: 1596911399971,
      ″gameOn″: 1596911399971,
      ″gameStartOn″: 1596911371775,
      ″gameid″: 1,
      ″isFirstCashGame″: false,
      ″playerRank″: 2,
      ″playerSeated″: 2,
      ″point Value″: 1,
      ″pointsLost″: 20,
      ″prizeType″: 2,
      ″revenue″: 1.5,
      ″serviceFee″: 12,
      ″tableSize″: 2,
      ″tableValue″: 1,
      ″tournamentId″: 515007067,
      ″userId″: ″Brian″,
      ″wagerAmount″: 80,
      ″winAmount″: 50,
      ″winnerAmount″: 17,
      ″won″: false
    }
  }
]
```

The properties are keys/values associated with that event. And each event type (e.g. “Game Played”) has a schema associated with it.

Identify events are similar in that they have an associated timestamp, but instead of properties, Identify events have traits.

Example Identify Event:

```
{
    ″channel″: ″mobile″,
    ″type″: ″identify″,
    ″messageId″: ″5736f726-6b3e-402c-a04b-da88b97249c7″
    ″timestamp″: ″2021 -03-22100:00:00.811Z″,
    ″context″: { },
    ″integrations″: { },
    ″userid″: ″ubi42″,
    ″traits″: {
      ″city″: ″Austin″,
      ″email″: ″brian@snapyr.com″
    }
  }
]
```

The traits are user traits and they are used to update the current/active user profile. An Identify event may be used to update a user's email address for example. Also similar to Track events, user profiles have schemas associated with them.

Example Traits on a User Profile:

```
{
  ″orgId″: ″576b06ef-0074-4148-8e35-860ac0b21774″,
  ″workspaceId″: ″8a4b03f3-420b-4c8b-9eeb-52aa49a69524″
  ″userId″: ″boneill42″,
  ″lastModified″ : ″5/5/2005″,
  ″gender″: ″male″,
  ″email″: ″boneill42@gmail.com″,
  ″phone″: ″555.389.7666″,
  ″age″: 42,
  ″currentBalance″: 0.0,
  ″cumulativeWinnings″: 0.0,
  ″pet_haven_player″: false,
  ″liveplay_bingo_player″: true,
  ″census_avg_income″: 50000,
  ″amount_won″ :0,
  ″date_of_birth″: ″11/23/1977″,
  ″seed″: 161556,
  ″game_scores″ : [1,2,3],
  ″events″ : [1,2,3,4]
}
```

The schemas in the system may be reactive, meaning that they adjust based on the events that the automated marketing system 100 detects. When a new event property is detected, the schema for that event type is extended to include that new field. When a new trait is detected, the schema for user profiles is extended to include that new field.

The automated marketing system 100 uses opportunistic coercion for data typing, which allows a single field in a schema to support multiple data types at once. For example, when a new field is first detected, the system attempts to coerce the field's value into multiple types, such as numbers, booleans, and dates. If it is possible to coerce, then the coerced value is stored along with original data type.

For example, if the automated marketing system 100 receives: the value “2157210359” as a text value for the field dateOfBirth, the automated marketing system 100 will attempt to coerce that value into a phone number, a date, a time, and a string:

{ ″dateOfBirth″ :
{ ″string″ : ″2157210359″,
″date″ : Date(May 11 2038 13:05:59 UTC-0400)
″phone″:+1 215-721-0359}
}

The automated marketing system 100 can coerce that value into three of the four types in this example. In this example, the system cannot coerce the value into a time because the value contains too many digits. This then allows the system to be extremely flexible in typing. Since the automated marketing system 100 stores the value as each type, this approach allows the marketing personnel to select which type they want to use for each field at run-time, after data ingestion, even though the original type may have been inferred via coercion. To allow for this flexibility, each field in a schema has one or more attributes/types associated with it, for example:

{ TypeConfirmed: ″date″
Typelngested: ″string″,
TypeInferred: ″phone″ :
}

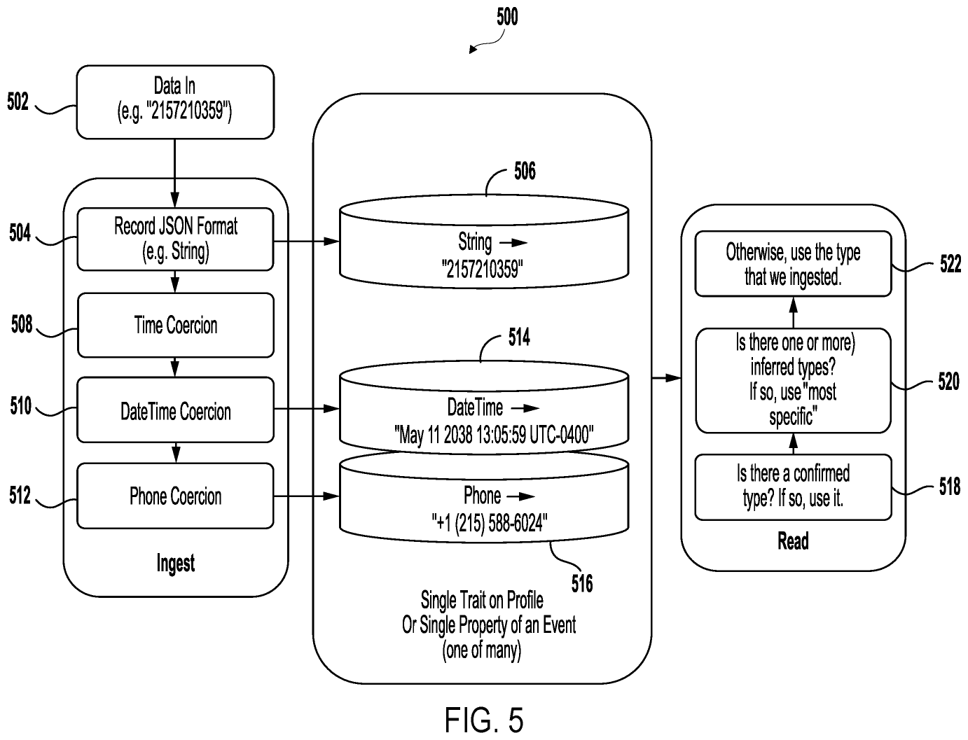

The automated marketing system 100 stores the type that it detected at ingestion (which may have been received via the JSON of the request). The automated marketing system 100 stores the type which was inferred (via coercion). The system stores the type which were confirmed via the UI 210. Since the system stores all the possible values, the marketing personnel is free to choose whatever data type is required to run the marketing operations they wish to process. In other words, when the data is read, the automated marketing system 100 first consults the schema to determine which data type should be used in that particular instance. An example flow for an opportunistic coercion operation is shown in FIG. 5.

Referring back to FIG. 2, the data plane 206 fetches the computer-executable workflow from the control plane 202 via the control plane API 212. The computer-executable workflow is then parsed and compiled on the backend. The automated marketing system 100 is configured to convert the criteria defined by audiences, the criteria embedded into blocks, or both, into Common Expression Language, which can then be compiled. This conversion makes evaluation extremely efficient.

Actions are generated as part of the processing. The action contains the channel through which the action should be executed and the fully rendered content. As part of the design, the channels may be kept as simple as possible by containing the logic within the Engine 224 of the data plane 206. The actions are queued as messages on the Action Queue 226. The IO plane 204 then consumes those messages from the Action Queue 226 and acts on them.

The importer 228 enables the marketer to upload user profile information to the system. The metrics database 230 collects and aggregates data about user behaviors and enables the system 100 to display performance information about the marketing operations. For example, the metrics database 230 stores a tally of button clicks, incrementing that metric every time a user performs that behavior. The events database 232 is a log of every event a user performs. The events database 232 is configured to store the raw event data. For example, when a user logs into an application, an event would be generate in response, and that event would be logged (e.g., stored) in the events database 232. The profiles database 234 is configured to store user traits. For example, the profiles database 234 may store a user's birthday or gender.

The IO plane 204 is a bidirectional interface with one or more software services 208 or communication channels. For email, the automated marketing system 100 may natively support and integrate with any email service, such as, for example, SendGrid. The automated marketing system 100 allows clients to bring their own email service accounts, by plugging in their API key. The action processor 236 is configured to read actions from the Action Queue 226 and perform (e.g., execute) those actions. For example, publishing an email is an action, which would include a header and content. The header may contain the user's email address and a subject line. The content would be the body of the email. The action processor 236 is configured to read that action off the Action Queue 226 and interact with a channel provider to send the email. A channel provider is a system that delivers the content. For example, an Email Service Provider (ESP) 240 is a channel provider. There are other providers such as text messaging services, such as short messaging services (SMS) 242 and push notification delivery mechanisms 244.

For push, the automated marketing system 100 may integrate with any notification service, such as, for example Amazon Web Services Simple Notification Service (AWS SNS). The automated marketing system 100 collects the device token in the mobile app via SDK. The device token is then configured in SNS and stored on the user profile for use in push notifications.

After the outbound communication, feedback may be received from the one or more software services or channels via a hypertext transfer protocol (HTTP) endpoint, which can be used via a Webhook integration with the software service or channel providers. The email service may be configured to post back to that HTTP endpoint with bounce and undeliverable information, which then feeds into the metrics for the campaign. The feedback processor 238 is the part of the automated marketing system 100 that receives the notification from the channel provider and adjusts metrics accordingly. For example, after an email is sent to a user via an ESP 240, the ESP 240 notifies the automated marketing system 100 that the delivery was successful. The automated marketing system 100 would then increment that metric accordingly.

One use case for implementing the automated marketing system 100 generating a marketing operation for a scenario where a player of a mobile slots game wins a big jackpot, a push notification is sent to all other players who have not played more than 2 times in the past month to notify them of this big win and encourage them to keep playing so they can also potentially win. In another example, an A/B test may be used to test different messages to these players to determine which message is more effective.

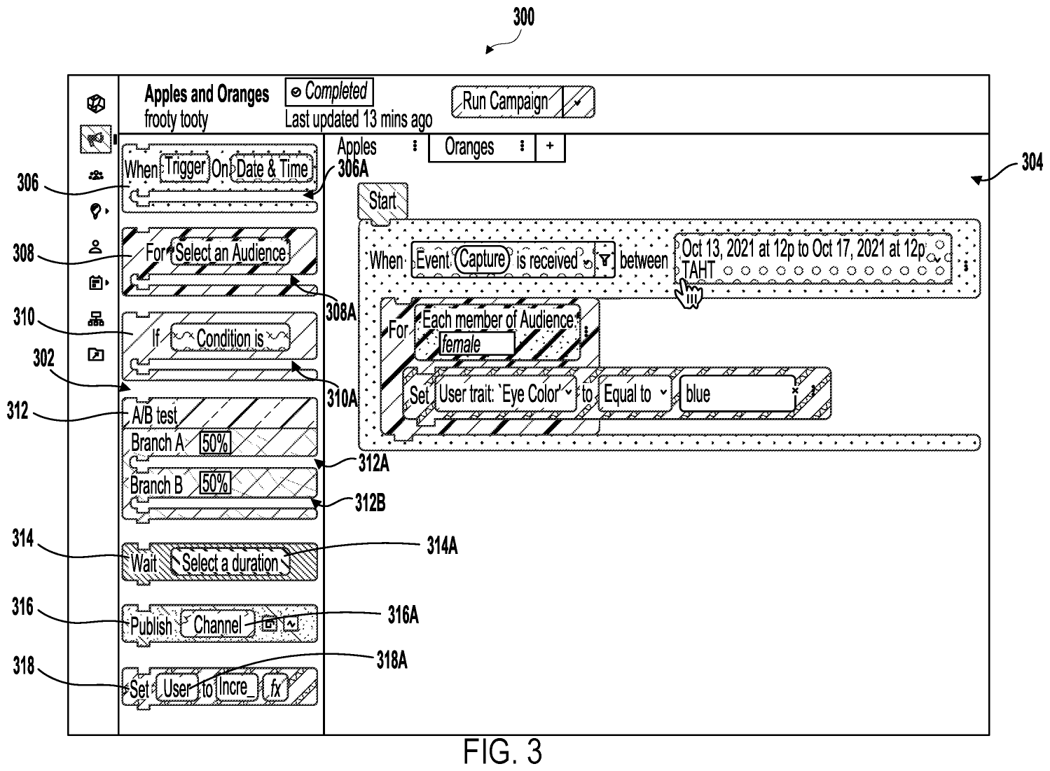

FIG. 3 is an example of a GUI display 300 of the automated marketing system 100 shown in FIG. 1. The GUI display 300 includes a panel 302 that contains blocks that can be dragged and dropped to an adjacent work area 304 to create a computer-executable workflow. Each block represents an instruction that performs a certain function. A processor of the automated marketing system 100 receives these instructions as input and executes them in the specified computer-executable workflow structure. The computer-executable workflow structure may be associated with one or more marketing operations.

Each block may represent a function or statement in a computer programming language. These blocks are specifically designed to address the needs of marketing personnel. Each block may be associated with one or more parameters. The one or more parameters may be associated with one or more marketing events. The blocks are configured with specific geometries to be visually connected to each other to represent an execution flow and adhere to a specific grammar and syntax in order to be a valid, computer-executable set of instructions. Blocks that can be visually connected to each other based on complimentary geometries indicate that the grammar and syntax of the combined blocks is valid. Conversely, blocks that cannot be visually connected to each other based on complimentary geometries indicate that the grammar and/or syntax of the combined blocks is invalid.

Each block is associated with a function that performs actions relevant to marketing operations. By assembling these blocks into a computer-executable workflow, the system can generate a large variety of rules and logic for marketing operations. Example blocks may include, and are not limited to, a when block 306, a for block 308, an if block 310, an A/B test block 312, a wait block 314, a publish block 316, and a set block 318. A when block may include a dropdown list of triggers, a dropdown list of dates and times, or both. The when block 306 may include an input 306A for one or more other blocks such that the one or more other blocks can be nested within the when block 306. A for block 308 may include an input for an audience selection. The for block 308 may include an input 308A for one or more other blocks such that the one or more other blocks can be nested within the for block 308. An if block 310 may include an input for a condition selection. The if block 310 may include an input 310A for one or more other blocks such that the one or more other blocks can be nested within the if block 310. An A/B test block 312 may include two or more branches, and each branch may have a configurable input 312A, 312B for percentage. In this example, 50% of the recipients will receive the Branch A action, and 50% of the recipients will receive the Branch B action. Each branch of the A/B test block 312 may include an input (e.g., configurable inputs 312A and 312B) for one or more other blocks such that the one or more other blocks can be nested within each branch of the A/B test block 312. A wait block 314 may include an input 314A for a duration of time. A publish block 316 include one or more inputs 316A, such as for channel selection, date/time selection, and the like. A set block 318 may include one or more inputs 318A, such as user input, function, or any other setting. Additional blocks may be added, including third-party developer blocks. A robust choice of blocks may provide marketing personnel with a rich ability to express their rules and logic.

The blocks include control logic, expression evaluation, variable instantiation, value assignment, message transmission capability, or any combination thereof. Control logic is a portion of a software program that controls operations of the program. The control logic can respond to commands from a user and can perform automated tasks, such as those of a computer-executable workflow structure. Expression evaluation refers to a block that can be used to evaluate an algebraic expression to find the value of the expression when the variable is replaced by a given number. To evaluate the expression, the given number is substituted for the variable in the expression and then the expression is simplified using the order of operations. Variable instantiation refers to a block that can be used to define non-static variables in a class outside any method, constructor, or block. Each instantiated object of the class can have a separate copy or instance of that variable. Value assignment refers to a block that can be used to assign a value to a variable. Message transmission capability refers to a block that can be used to transmit a message. The implementation of these blocks enables marketing personnel much more power in designing their marketing operations than existing approaches. The blocks may include artificial intelligence (AI) and machine learning (ML) tools that can be used to optimize marketing operations. For example, the system may use AI and ML tools to suggest an optimal send time for a particular message.

These blocks may enable a user to express operations that have arbitrarily complex rules and logic. The blocks enable a user to express operations similar to a programming language, but without the complexities of having to learn a programming language. The blocks are extensible by third-party developers who can provide their own functions in the form of libraries. For example, third-party developers can provide their own library of custom blocks. As marketing operations logic becomes complex, flowcharts quickly become messy, hard to manipulate and hard to understand. These blocks provide a visual motif that is much easier to understand and modifying the underlying code is also much easier than in typical programming.

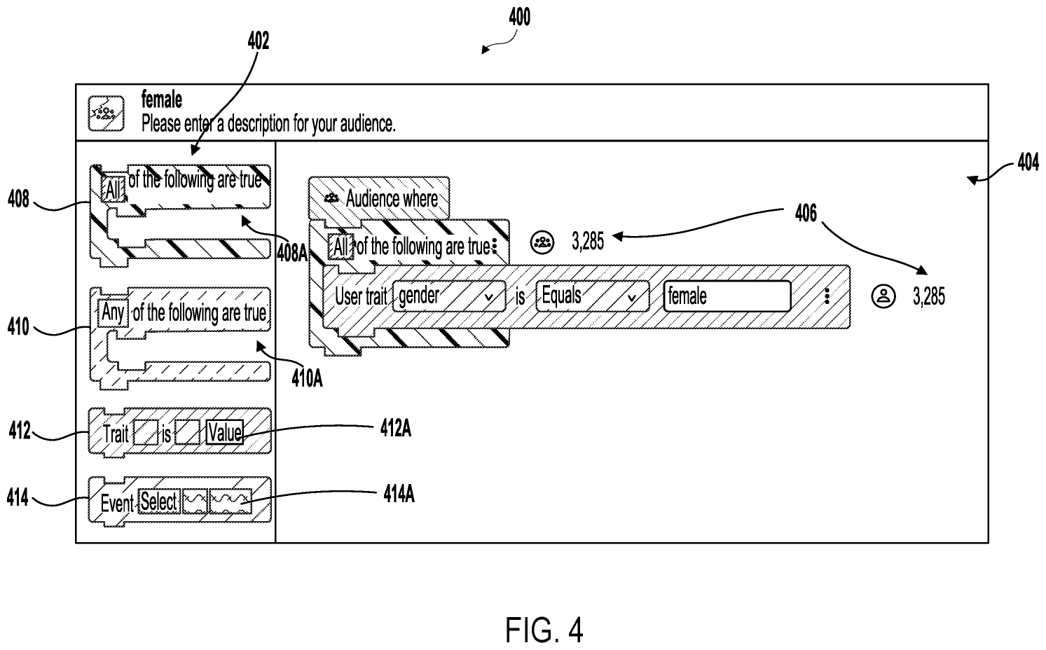

FIG. 4 is an example of a GUI display 400 of the automated marketing system for creating an audience. The GUI display 400 includes a panel 402 that contains blocks that can be dragged and dropped to an adjacent work area 404 to create a computer-executable workflow. As blocks are moved into the work area, real-time data may be obtained from a database and displayed. As shown in FIG. 4, as each block is moved into place in the work area 404, the size of the audience 406 is shown in real-time adjacent to each block. In this example, the panel 402 may contain an all block 408, an any block 410, a trait block 412, and an event block 414. The all block 408 may include an input 408A for one or more other blocks such that the one or more other blocks can be nested within the all block. In an example, the all block 408 may be used to generate an operation where all of the nested inputs are true. The any block 410 may include an input 410A for one or more other blocks such that the one or more other blocks can be nested within the any block. In an example, the any block 410 may be used to generate a campaign where one or more of the nested inputs are true. The trait block 412 may include one or more inputs 412A associated with a trait of a target user. The event block 414 may include one or more inputs 414A associated with an event that triggers a message to be transmitted to the target user.

FIG. 5 is an example flow diagram 500 for an opportunistic coercion operation. A system, such as the automated marketing system 100 shown in FIG. 1, obtains data 502 and records 504 the obtained data in JSON format. The obtained data can be stored as a string 506. The system performs a time coercion 508, a date time coercion 510, and a phone coercion 512. In this example, the obtained data cannot be coerced into a time format, however, the obtained data can be coerced into a date time format and phone format. The coerced data is respectively stored in a date time format 514 and a phone format 516. In this example, the string 506, the date time format 514, the phone format 516, or any combination thereof, may be stored as a single trait on a profile or a single property of an event.

When the system reads the stored data, the system may determine 518 whether the data is associated with a confirmed type. If it is determined that the data is associated with a confirmed type, the system will use that type. If it is determined that the data is not associated with a confirmed type, the system determines 520 whether the data is associated with one or more inferred types. If it is determined that the data is associated with an inferred type, the system will use the most specific (i.e., most relevant), for example, based on a relevance score. If it is determined 522 that the data is not associated with an inferred type, the system will use the type that was ingested.

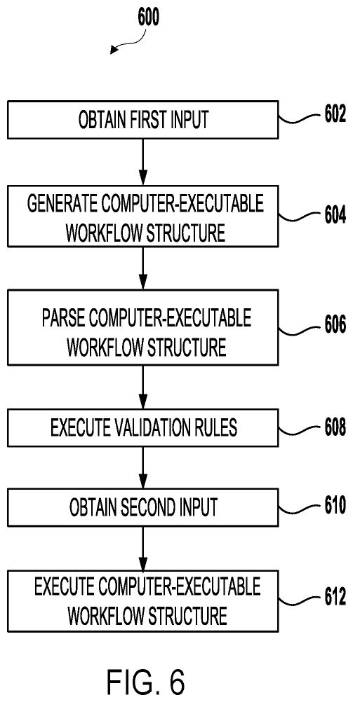

FIG. 6 is a flow diagram of an example of an automated marketing method 600. The method 600 includes obtaining 602 a first input. Obtaining the first input may include obtaining data associated with one or more blocks. The first input may be obtained via a UI. The method 600 includes generating 604 a computer-executable workflow structure based on the first input. The computer-executable workflow structure may be associated with a marketing operation. The computer-executable workflow structure may be generated in JSON. The method 600 may include parsing 606 the computer-executable workflow structure to obtain a parsed structure. In some examples, the parsed structure may be converted into Common Expression language and compiled. The method 600 may include executing 608 one or more validation rules against the parsed structure to determine whether the computer-executable workflow structure is valid. The method 600 includes obtaining 610 a second input. The second input may be an indication to publish or execute the marketing operation. The method 600 may include executing 612 the computer-executable workflow structure in response to the second input when the computer-executable workflow structure is valid. When the computer-executable workflow structure is invalid, the method may include displaying a notification. In some examples, the method 600 may include obtaining metrics based on the executed workflow structure.

Executing the computer-executable workflow structure may include determining an audience based on the parsed structure. In some examples, executing the computer-executable workflow structure may include generating a message based on the parsed structure. In some examples, executing the computer-executable workflow structure may include transmitting the message to the audience.

In some examples, the method 600 may include obtaining event information from an end-user device. In these examples, the method 600 may include transmitting the message to the end-user device based on the event information.

Although some embodiments herein refer to methods, it will be appreciated by one skilled in the art that they may also be embodied as a system or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “processor,” “device,” or “system.” Furthermore, aspects of the present invention may take the form of a computer program product embodied in one or more computer readable mediums having computer readable program code embodied thereon. Any combination of one or more computer readable mediums may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to CDs, DVDs, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The flowcharts and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An automated marketing method comprising:
obtaining a first input via a user interface (UI);
generating a computer-executable workflow structure associated with a marketing operation based on the first input;
parsing the computer-executable workflow structure to obtain a parsed structure;
executing validation rules against the parsed structure to determine whether the computer-executable workflow structure is valid;
obtaining a second input; and
executing the computer-executable workflow structure in response to the second input when the computer-executable workflow structure is valid.

2. The method of claim 1, further comprising:
displaying a notification on the UI when the computer-executable workflow structure is invalid.

3. The method of claim 1, wherein the computer-executable workflow structure is generated in JavaScript Object Notation (JSON).

4. The method of claim 1, wherein executing the computer-executable workflow structure includes:
determining an audience based on the parsed structure;
generating a message based on the parsed structure; and
transmitting the message to the audience.

5. The method of claim 4, further comprising:
obtaining event information from an end-user device; and
transmitting the message to the end-user device based on the event information.

6. The method of claim 1, wherein the parsed structure is converted into Common Expression Language and compiled.

7. The method of claim 1, further comprising:
obtaining metrics based on the executed computer-executable workflow structure.

8. An automated marketing system comprising:
a server comprising a processor configured to:
obtain a first input via a user interface (UI);
generate a computer-executable workflow structure associated with a marketing operation based on the first input;
parse the computer-executable workflow structure to obtain a parsed structure;
execute validation rules against the parsed structure to determine whether the computer-executable workflow structure is valid;
obtain a second input; and
execute the computer-executable workflow structure in response to the second input when the computer-executable workflow structure is valid.

9. The automated marketing system of claim 8, wherein the processor is further configured to:
display a notification on the UI when the computer-executable workflow structure is invalid.

10. The automated marketing system of claim 8, wherein the computer-executable workflow structure is generated in JavaScript Object Notation (JSON).

11. The automated marketing system of claim 8, wherein the processor is further configured to:
determine an audience based on the parsed structure;
generate a message based on the parsed structure; and
transmit the message to the audience.

12. The automated marketing system of claim 11, wherein the processor is further configured to:
obtain event information from an end-user device; and
transmit the message to the end-user device based on the event information.

13. The automated marketing system of claim 8, wherein the processor is further configured to:
convert the parsed structure into Common Expression Language; and
compile the converted parsed structure.

14. The automated marketing system of claim 8, wherein the processor is further configured to:
obtain metrics based on the executed computer-executable workflow structure.

15. A non-transitory computer-readable medium comprising instructions stored in a memory, that when executed by a processor, cause the processor to perform operations comprising:
obtaining a first input via a user interface (UI);
generating a computer-executable workflow structure associated with a marketing operation based on the first input;
parsing the computer-executable workflow structure to obtain a parsed structure;
executing validation rules against the parsed structure to determine whether the computer-executable workflow structure is valid;
obtaining a second input; and
executing the computer-executable workflow structure in response to the second input when the computer-executable workflow structure is valid.

16. The non-transitory computer-readable medium of claim 15, wherein the operations further comprise:
displaying a notification on the UI when the computer-executable workflow structure is invalid.

17. The non-transitory computer-readable medium of claim 15, wherein the computer-executable workflow structure is generated in JavaScript Object Notation (JSON).

18. The non-transitory computer-readable medium of claim 15, wherein executing the computer-executable workflow structure includes:
determining an audience based on the parsed structure;
generating a message based on the parsed structure; and
transmitting the message to the audience.

19. The non-transitory computer-readable medium of claim 18, wherein the operations further comprise:
obtaining event information from an end-user device; and
transmitting the message to the end-user device based on the event information.

20. The non-transitory computer-readable medium of claim 15, wherein the operations further comprise:
obtaining metrics based on the executed computer-executable workflow structure.
